(19) United States
(12) Patent Application Publication
(10) Pub. No.: US 2014/0023779 A1
(43) Pub. Date: Jan. 23, 2014

(54) CONDUCTIVE COPPER PASTE COMPOSITION AND METHOD OF FORMING METAL THIN FILM USING THE SAME

(71) Applicant: SAMSUNG ELECTRO-MECHANICS CO., LTD., Suwon (KR)

(72) Inventors: Sung Il OH, Suwon (KR); Kwi Jong LEE, Suwon (KR); Dong Hoon KIM, Suwon (KR)

(73) Assignee: SAMSUNG ELECTRO-MECHANICS CO., LTD., Suwon (KR)

(21) Appl. No.: 13/841,795

(22) Filed: Mar. 15, 2013

(30) Foreign Application Priority Data
Jul. 18, 2012 (KR) 10-2012-0078424

(51) Int. Cl. C09D 5/24

(52) U.S. Cl. CPC C09D 5/24
USPC 427/126.1; 252/512

(57) ABSTRACT

There are provided a conductive copper paste composition and a method of forming a metal thin film using the same, wherein the conductive copper paste composition includes a back bone chain particle formed of copper (Cu) or a copper alloy containing copper (Cu); and an organic copper compound, have excellent electrical characteristics even at the time of low-temperature heat treatment process and suppress an increase in a viscosity depending on the time.

### CROSS-REFERENCE TO RELATED APPLICATIONS

This application claims the priority of Korean Patent Application No. 10-2012-0078424 filed on Jul. 18, 2012, in the Korean Intellectual Property Office, the disclosure of which is incorporated herein by reference.

### BACKGROUND OF THE INVENTION

1. Field of the Invention

The present invention relates to a copper paste composition capable of having excellent electrical characteristics in a low-temperature heat treatment process, and a method of forming a metal thin film using the same.

2. Description of the Related Art

Recently, in accordance with the trend for miniaturization and lightness in electronic devices information terminal devices, and the like, electronic components used in the devices have been correspondingly miniaturized.

Therefore, sizes of wiring patterns to be mounted in electronic components have been increasingly reduced, and widths of wiring patterns or spaces between wiring patterns have been narrowed.

In addition, since a process for manufacturing an electronic device difficult to manufacture in a high temperature heat treatment process such as a plastic substrate and the like has recently been introduced, a material for forming conductive wirings through a heat treatment at a low temperature is increasingly required.

In general, when electronic devices are manufactured, as a process for forming conductive wirings, for example, a process including printing a metal paste and then performing a heat treatment (firing) thereon has been widely used.

In particular, a conductive paste having silver (Ag) as a main material has been widely used because it may be employable in both low temperature and high temperature processes, due to low specific resistance and excellent oxidation resistance properties of the silver (Ag).

However, due to the relatively high cost of silver, it is not financially viable as a material for forming conductive wirings of electronic devices. Therefore, research into a technology utilizing a low cost metal such as copper (Cu), nickel (Ni), or the like, has been continued.

Research into a technology utilizing a low cost metal such as copper (Cu), nickel (Ni), or the like, and research into a technology utilizing a plastic substrate, or the like, difficult to be manufactured in a high temperature heat treatment process are required.

The related art document, Korean Patent Laid-Open Publication No. 2011-0050175, discloses an ink composition for wiring including copper nano particles capable of allowing the heat treatment to be performed at a low temperature. However, it may be difficult to prepare nano particles having low temperature activity.

In addition, since a lipid acid, an amine, or the like, used in order to secure dispersion stability may degrade compatibility of the copper nano particles with an epoxy resin and a solvent widely used for manufacturing an electronic device, it is difficult to utilize copper nano particles.

### [Related Art Document]

(Patent Document 1) Korean Patent Laid-Open Publication No. 2011-0050175

### SUMMARY OF THE INVENTION

An aspect of the present invention provides a conductive copper paste composition capable of having excellent electrical characteristics in a low temperature heat treatment process, and a method of forming a metal thin film using the same.

According to an aspect of the present invention, there is provided a conductive copper paste composition including: a particle formed of copper (Cu) or a copper alloy containing copper (Cu) and forming a back bone chain; and an organic copper compound.

The particle may have an average particle diameter of 0.1 to 100 μm.

The organic copper compound may be copper alkanoate in which copper (Cu) atoms are combined with an alkanoate compound.

The alkanoate compound may have 12 or less carbon atoms.

The organic copper compound may be a ligand biding compound having an unshared electron pair with a copper (Cu) atom.

The organic copper compound may include an isomer in which a branched chain is combined with an alkyl chain of an organic compound.

The organic copper compound may have a content of 0.5 to 50 wt %.

The composition may further include at least one organic solvent selected from a group consisting of methanol, ethanol, isopropanol, butanol, ethyleneglycol, glycerole, diethylene glycole, ethyl acetate, butyl acetate, propyl acetate, methylethyl ketone, acetone, benzene, tetradecane, and toluene.

The composition may further include at least one binder selected from a group consisting of an epoxy resin, a melamine resin, an acrylic resin, an ethyl cellulose resin, and an imide resin.

According to another aspect of the present invention, there is provided a method of forming a metal thin film, the method including: preparing a substrate formed of an organic material or an inorganic material; applying a conductive copper paste composition including a particle formed of copper (Cu) or a copper alloy containing copper (Cu) and forming a backbone chain and an organic copper compound to the substrate, to form a metal thin film thereon; and performing a heat-treatment on the substrate.

The heat treatment may be performed at 300° C. or less.

The particle may have an average particle diameter of 0.1 to 100 μm.

The organic copper compound may include an isomer in which a branched chain is combined with an alkyl chain of an organic compound.

The organic copper compound may be copper alkanoate in which copper (Cu) atoms are combined with an alkanoate compound.

The alkanoate compound may have 12 or less carbon atoms.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a thermogravimetric analysis (TGA) graph showing low temperature pyrolysis characteristics of an organic copper compound according to an embodiment of the present invention;

FIG. 2 is a graph showing a change in viscosity of the organic copper compound according to the embodiment of the present invention, over time; and

FIG. 3 is a scanning electron microscope (SEM) photograph showing copper protrusions deposited on a surface of a copper particle according to the embodiment of the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

A conductive copper paste composition according to an embodiment of the present invention may include a particle formed of copper (Cu) or a copper alloy containing copper (Cu) and forming a back bone chain; and an organic copper compound.

The particle formed of copper (Cu) or a copper alloy containing copper (Cu) and forming a back bone chain may have an average particle diameter of 0.1 to 100 μm, but is not limited thereto.

In the case in which the average particle diameter of the particle is less than 0.1 μm, an average particle diameter of copper is excessively small, such that the particle may be aggregated to deteriorate dispersion stability thereof.

In the case in which the average particle diameter of the particle is more than 100 μm, the average particle diameter of copper is excessively large, such that it may be difficult to perform a low temperature heat treatment on a conductive copper paste composition.

The particle formed of copper (Cu) or a copper alloy containing copper (Cu) and forming a back bone chain is not specifically limited, in terms of shape. That is, the particle may have, for example, a globular shape, a flake shape, an indeterminate form, or the like, according to a purpose of the present invention.

In addition, a copper alloy containing copper may be an alloy of copper and a metal different to the copper, or a mixture thereof. An example of the metal different to the copper may include nickel (Ni), cobalt (Co), manganese (Mn), iron (Fe), and the like, but is not specifically limited thereto.

In the organic copper compound in which an organic compound is combined with copper (Cu) atoms, the organic compound may be decomposed at a low temperature of 300° C. or lower, such that only copper (Cu) atoms remain.

In this case, in the remaining copper (Cu) atoms, adjacent copper atoms may be combined with each other to have an increased size or may be deposited on a surface of the particle formed of copper (Cu) or a copper alloy containing copper and forming a back bone chain.

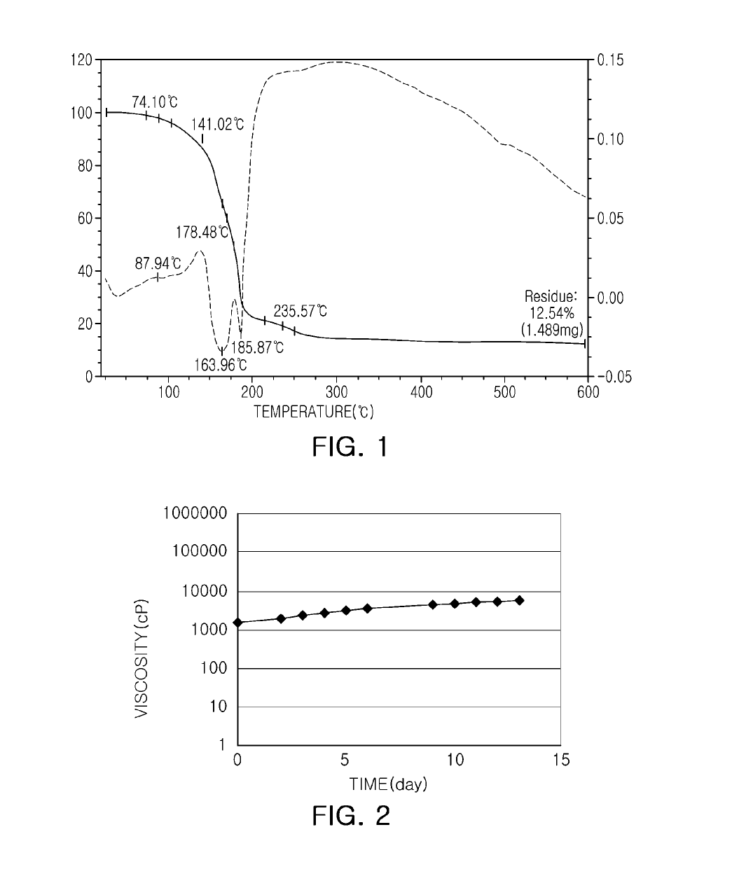

FIG. 1 is a thermogravimetric analysis (TGA) graph showing low temperature pyrolysis characteristics of an organic copper compound according to an embodiment of the present invention.

Referring to FIG. 1, it can be appreciated that the organic copper compound according to the embodiment of the present invention is pyrolyzed at about 200° C.

In general, in order to prepare a conductive copper paste for a low temperature firing, copper nano particles having high activity even at a low temperature are utilized. However, it is difficult to prepare copper nano particles and dispersion stability thereof may be deteriorated.

In addition, since a lipid acid, an amine, and the like, used in order to secure the dispersion stability may degrade compatibility of the conductive copper paste with an epoxy resin and a solvent widely used for manufacturing an electronic device, it may be difficult to utilize the conductive copper paste.

According to the embodiment of the present invention, the conductive copper paste composition including the organic copper compound may have excellent electrical characteristics and excellent compatibility with the epoxy resin and the solvent used together with the epoxy resin even at the time of low-temperature firing.

The organic copper compound may be copper alkanoate in which copper (Cu) atoms are combined with an alkanoate compound, but is not limited thereto.

The organic copper compound may allow copper alkanoate to be synthesized by reacting an alkanoate compound with a copper salt, and may be a ligand binding compound having an unshared electron pair with a copper (Cu) atom.

In particular, pyrolysis characteristics of the organic copper compound and compatibility thereof with a solvent are significantly related to a length of an alkyl chain of alkanoate. In general, a hexanoate or octanoate compound, or the like, having six to eight carbon atoms may be pyrolyzed at about 200□.

Therefore, according to the embodiment of the present invention, the alkanoate compound may have 12 or less carbon atoms, but is not limited thereto.

In the case in which the alkanoate compound has 12 or more carbon atoms, since a length of an alkyl chain of the alkanoate is excessively long, it may be difficult to prepare a conductive copper paste for low temperature firing, the purpose of the present invention.

In addition, the organic copper compound may have excellent compatibility with solvents including ethers such as butyl carbitol, or the like, generally used in the epoxy paste, or ketones such as methylethylketone (MEK), or the like, used for manufacturing electronic devices.

The organic compound of the organic copper compound according to the embodiment of the present invention may have a alkyl chain structure as described above. However, in the case in which the length of the alkyl chain is relatively long, as time passes or temperature is lowered, a gelation phenomenon may be generated due to attractive force between the chains.

The gelation phenomenon may result in an increase in a viscosity of the paste.

Therefore, the organic copper compound according to the embodiment of the present invention may include an isomer in which a branched chain is combined with the alkyl chain of the organic compound.

The branched chain combined with the alkyl chain may effectively prevent the gelation phenomenon due to attractive force between the alkyl chains (van der Waals attraction force, or the like) by steric hindrance.

By suppressing the gelation phenomenon as described above, the conductive copper paste composition according to the embodiment of the present invention may restrain an increase in viscosity over time.

The organic copper compound including an isomer having a branched chain combined with the alkyl chain of the organic compound may be copper-2-ethylhexanoate-ethanolamine, but is not specifically limited thereto.

FIG. 2 is a graph showing a change in viscosity of the organic copper compound according to the embodiment of the present invention, over time.

In particular, FIG. 2 is a graph showing the change in viscosity over time in the case in which the organic copper compound including an isomer having a branched chain combined with the alkyl chain of the organic compound is contained in the content of 70 wt % in a butyl carbitol solvent.

Referring to FIG. 2, it can be appreciated that the change in the viscosity of the organic copper compound including the isomer having a branched chain combined with the alkyl chain of the organic compound is significantly low over time.

Therefore, the conductive copper paste composition including the organic copper compound according to the embodiment of the present invention has a small change in viscosity over time, thereby exhibiting excellent stability.

The content of the organic copper compound may be, for example, 0.5 to 50 wt %, but is not specifically limited thereto.

In the case in which the content of the organic copper compound is less than 0.5 wt %, since the content of the organic copper compound to be added is extremely small, it may be difficult to perform a low temperature firing.

In the case in which the content of the organic copper compound is higher than 50 wt %, since the content of the organic copper compound to be added is extremely large, copper particles are larger or aggregated, whereby viscosity of the paste may be increased over time.

The conductive copper paste composition may further include at least one organic solvent selected from a group consisting of methanol, ethanol, isopropanol, butanol, ethyleneglycol, glycerole, diethylene glycole, ethyl acetate, butyl acetate, propyl acetate, methylethyl ketone, acetone, benzene, tetradecane, and toluene, but is not limited thereto.

According to the embodiment of the present invention, the conductive copper paste composition includes the organic copper compound, such that the conductive copper paste composition may have excellent compatibility with the organic solvent.

The composition may further include at least one binder selected from a group consisting of an epoxy resin, a melamine resin, an acrylic resin, an ethyl cellulose resin, and an imide resin, but is not limited thereto.

A method of forming a metal thin film according to another embodiment of the present invention may include: preparing a substrate formed of an organic material or an inorganic material; applying the conductive copper paste composition including a particle formed of copper (Cu) or a copper alloy containing copper (Cu) and forming a back bone chain and the organic copper compound to the substrate, to form the metal thin film thereon; and performing a heat-treatment on the substrate.

As described above, the conductive copper paste composition may have excellent electrical characteristics even at the time of low-temperature firing, and may have excellent compatibility with an epoxy resin and a solvent used together with the epoxy resin.

Therefore, the conductive copper paste composition may be used for forming a metal thin film on a substrate having low thermal stability.

According to the embodiment of the present invention, first, a substrate formed of an organic or an inorganic material may be prepared.

The substrate may be formed of bismaleimide triazine, a polyester, a polyimide, glass, silicone, or the like, but is not limited thereto.

Then, the metal thin film may be formed by applying an ink for forming a metal thin film to the substrate formed of an organic or inorganic material.

The metal thin film may be formed by various printing methods, for example, dip coating, spin coating, roll coating, spray coating or inkjet printing, but is not limited thereto.

Then, a heat-treatment is performed to form the metal thin film. The heat-treatment may be performed at 300° C. or less.

In addition, the heat-treatment may be performed in the air, or in the atmosphere mixed with an inert gas such as nitrogen, argon, hydrogen, or the like.

The particle formed of copper (Cu) or a copper alloy containing copper (Cu) and forming a back bone chain may have an average particle diameter of 0.1 to 100 μm.

The organic copper compound may include an isomer having a branched chain combined with an alkyl chain of the organic compound.

The organic copper compound may be copper alkanoate in which copper (Cu) atoms combined with an alkanoate compound.

The alkanoate compound may have 12 or less carbon atoms.

Since the characteristics of the conductive copper paste component according to another embodiment of the present invention are the same as those of the conductive copper paste component according to the embodiment of the present invention as described above, a description thereof will be omitted.

In the substrate on which the metal thin film manufactured by the method of forming the metal thin film according to another embodiment of the present invention is formed, the organic compound may be decomposed at a low temperature, such that only copper (Cu) atoms remain.

In this case, in the remaining copper (Cu) atoms, adjacent copper atoms may be combined with each other to have an increased size or may be deposited on a surface of the particle formed of copper (Cu) or a copper alloy containing copper and forming a back bone chain.

Therefore, the copper paste composition including the organic copper compound may be subjected to a low temperature heat treatment process to thereby having excellent electrical characteristics.

In addition, the copper paste composition according to the embodiment of the present invention has excellent compatibility with the epoxy resin and the solvent used together with the epoxy resin to maintain the high adhesive strength, whereby the manufactured substrate may have excellent reliability.

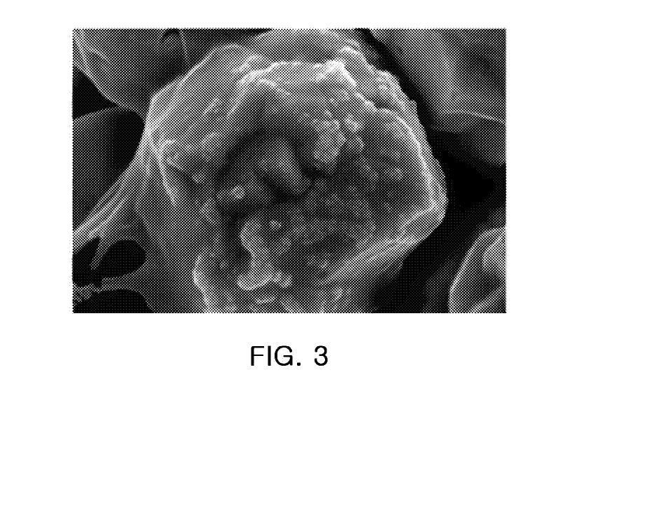

FIG. 3 is a scanning electron microscope (SEM) photograph showing copper protrusions deposited on a surface of a copper particle according to the embodiment of the present invention.

Referring to FIG. 3, it can be appreciated that the organic copper compound in which copper (Cu) atoms are combined with the organic compound was decomposed at 200° C. to be deposited on the surface of the particle formed of copper (Cu) or a copper alloy containing copper and forming a back bone chain.

Hereinafter, although the present invention will be described in detail with reference to examples, which has been disclosed for illustrative purposes, it is not limited thereto.

An example of the organic copper compound may include copper-2-octanoate-ethanolamine and copper-2-ethylhexanoate-ethanolamine, prepared by mixing octanoate with a copper (Cu) salt, and ethylhexanoate with a Cu salt, respectively.

### Inventive Examples 1 and 2

The organic copper compound prepared as described above and a flake type particle formed of copper (Cu), forming a back bone chain, and having an average particle diameter of 4 μm were input into a butyl carbitol solvent, and then mixed with an epoxy resin to thereby prepare a conductive copper paste.

Specific composite ratios of the respective components are shown in Table 1 below.

The prepared conductive copper paste was printed on a substrate by using an inkjet printing, had a heat treatment performed thereon under nitrogen (N₂) atmosphere at 200° C. for 1 hour, and a specific resistance thereof was then measured.

### Comparative Example

The Comparative Example used the same components as the conductive copper paste prepared in Inventive Examples 1 and 2 except for not using the organic copper compound.

Specific composite ratios of the respective components are shown in Table 1 below.

In the Comparative Example, like Inventive Examples 1 and 2 above, the produced conductive copper paste was printed on a substrate by using an inkjet printing, had a heat treatment performed thereon under nitrogen (N₂) atmosphere at 200° C. for 1 hour, and a specific resistance thereof was then measured.

TABLE 1

| | Back bone | | | | |
|---|---|---|---|---|---|
| | chain | | | | |
| | Copper | Organic | Epoxy | Butyl | Specific |
| | Particle | Copper | Resin | Carbitol | Resistance |
| | (wt %) | (wt %) | (wt %) | (wt %) | (μΩ.cm) |
| Comparative | 70.6 | — | 10.3 | 19.1 | 5.652 |
| Example | | | | | |
| Inventive | 68.8 | 6.7 | 10.4 | 14.3 | 70 |
| Example 1 | | | | | |
| Inventive | 66.8 | 6.7 | 9.7 | 16.8 | 79 |
| Example 2 | | | | | |

Referring to Table 1 above, it can be appreciated that the cases of Inventive Examples 1 and 2 using the organic copper compound had specific resistance lower than 70 times or more as compared to the Comparative Example not using the organic copper compound.

In particular, in the case of Inventive Example 2 having a structure in which a branched chain is combined with an alkyl chain, the change in viscosity over time is small, resulting in excellent stability.

Therefore, it can be appreciated that the conductive copper paste according to the embodiment of the present invention includes the organic copper compound, such that the conductive copper paste may have excellent electrical characteristics even in a low-temperature heat treatment process.

As set forth above, according to embodiments of the present invention, the copper paste composition including the organic copper compound can have excellent electrical characteristics in a low temperature heat treatment process.

In addition, the copper paste composition according to the embodiment of the present invention has excellent compatibility with the epoxy resin and the solvent used together with the epoxy resin to maintain high adhesive strength, whereby a product to which the copper paste composition applied can have excellent reliability.

Further, the isomer in which the branched chain is combined with the alkyl chain of the organic compound is applied to the organic copper compound of the copper paste composition, such that the gelation phenomenon of the copper paste composition may be effectively prevented to suppress the increase in viscosity over time.

While the present invention has been shown and described in connection with the embodiments, it will be apparent to those skilled in the art that modifications and variations can be made without departing from the spirit and scope of the invention as defined by the appended claims.

What is claimed is:

1. A conductive copper paste composition comprising:
a particle formed of copper (Cu) or a copper alloy containing copper (Cu) and forming a back bone chain; and
an organic copper compound.

2. The conductive copper paste composition of claim 1, wherein the particle has an average particle diameter of 0.1 to 100 μm.

3. The conductive copper paste composition of claim 1, wherein the organic copper compound is copper alkanoate in which copper (Cu) atoms are combined with an alkanoate compound.

4. The conductive copper paste composition of claim 3, wherein the alkanoate compound has 12 or less carbon atoms.

5. The conductive copper paste composition of claim 1, wherein the organic copper compound is a ligand biding compound having an unshared electron pair with a copper (Cu) atom.

6. The conductive copper paste composition of claim 1, wherein the organic copper compound includes an isomer in which a branched chain is combined with an alkyl chain of an organic compound.

7. The conductive copper paste composition of claim 1, wherein the organic copper compound has a content of 0.5 to 50 wt %.

8. The conductive copper paste composition of claim 1, wherein the composition further includes at least one organic solvent selected from a group consisting of methanol, ethanol, isopropanol, butanol, ethyleneglycol, glycerole, diethylene glycole, ethyl acetate, butyl acetate, propyl acetate, methylethyl ketone, acetone, benzene, tetradecane, and toluene.

9. The conductive copper paste composition of claim 1, wherein the composition further includes at least one binder selected from a group consisting of an epoxy resin, a melamine resin, an acrylic resin, an ethyl cellulose resin, and an imide resin.

10. A method of forming a metal thin film, the method comprising:
preparing a substrate formed of an organic material or an inorganic material;
applying a conductive copper paste composition including a particle formed of copper (Cu) or a copper alloy containing copper (Cu) and forming a back bone chain and an organic copper compound to the substrate, to form a metal thin film thereon; and
performing a heat-treatment on the substrate.

11. The method of claim 10, wherein the heat treatment is performed at 300° C. or less.

12. The method of claim 10, wherein the particle has an average particle diameter of 0.1 to 100 μm.

13. The method of claim 10, wherein the organic copper compound includes an isomer in which a branched chain is combined with an alkyl chain of an organic compound.

14. The method of claim 10, wherein the organic copper compound is copper alkanoate in which copper (Cu) atoms are combined with an alkanoate compound.

15. The method of claim 14, wherein the alkanoate compound has 12 or less carbon atoms.
